(19) United States
(12) Patent Application Publication
(10) Pub. No.: US 2007/0067816 A1
(43) Pub. Date: Mar. 22, 2007

(54) Fast service scan for digital television receivers

(75) Inventors: Hendrikus G. Van Horck, Eindhoven (NL); Serge A. M. Hermans, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics., N.V., Eindhoven (NL)

(21) Appl. No.: 10/567,391

(22) PCT Filed: Aug. 4, 2004
(86) PCT No.: PCT/IB04/51392

§ 371 Date: Nov. 14, 2006

Related U.S. Application Data
(60) Provisional application No. 60/493,273, filed on Aug. 7, 2003.
(60) Provisional application No. 60/529,598, filed on Dec. 15, 2003.

(51) Int. Cl. H04N 7/16; H04N 7/173

(52) U.S. Cl. 725/100; 725/131; 725/139

(57) ABSTRACT

A fast service scan is provided for recovering programming services in a received digital data transmission, such as a digital television transmission. A receiver (100) stores frequency data (104) for different transmission standards, as well as a country or region setting (105) based on the location of the receiver. The frequency data may be provided, e.g., via a software download, flash card, or pre-programming. The service scan is initiated when a reset or installation of the receiver occurs. The frequency data for the identified transmission standard is identified, and used to control a tuner (102) at the receiver to tune only to the identified frequencies to recover the programming services, thereby reducing the scan time.

The invention relates generally to digital television communications and, more particularly, to a technique for providing a fast service scan for digital data receivers such as television receivers.

Digital television communications have become increasingly popular due to the quality of the audio and video signals and the various features that can be realized. For example, standards defined by the Digital Video Broadcasting (DVB) consortium have been implemented in many parts of the world. Among other things, these standards include a series of transmission specifications, including DVB-S, a satellite transmission standard, DVB-C, a cable delivery standard, and DVB-T, a terrestrial transmission standard. DVB-T is a sophisticated and flexible digital terrestrial transmission system that is based on COFDM (Coded Orthogonal Frequency Divisional Multiplexing) and QPSK, 16 QAM and 64 QAM modulation. DVB-T allows services providers to match, and even improve on, analogue coverage, at a fraction of the power. Moreover, it extends the scope of digital terrestrial television in the mobile field, such as to portable hand-held devices.

Upon a first time installation or a reset, the digital television receiver attempts to identify the services in the received transmission. This can be done by scanning each of the possible frequencies in which a signal may be present. For example, this may include channels 21-69 of the UHF frequency spectrum. This is an automatic search that finds all of the multiplexes and services in the whole frequency range. It is also possible for the user to perform a manual search by entering a channel number. The receiver tunes to the designated channel and adds all new services and replaces existing services in the service list. However, either approach is time consuming. For example, the full range scan can take up to twenty minutes for most receivers. This can be very inconvenient for the user.

The present invention addresses the above and other issues by providing a fast service scan for digital data receivers such as television receivers.

In a particular aspect of the invention, a method for receiving a digital data transmission includes storing data identifying frequencies at which digital data is transmitted according to different transmission standards, identifying a particular one of the different transmission standards that is associated with the received digital data transmission, and locating programming services in the received digital data transmission by controlling a tuner to scan only the identified frequencies associated with the particular one of the different transmission standards.

In a further aspect of the invention, a method is provided for configuring a receiver to receive a digital data transmission, wherein the receiver includes a tuner that is capable of scanning a predetermined set of frequencies, and at least one memory. The method includes storing data in the at least one memory for identifying a subset of the predetermined set of frequencies at which digital data is transmitted according to at least one transmission standard, and controlling the tuner to locate programming services in the received digital data transmission by scanning only the subset of the predetermined set of frequencies.

Corresponding program storage devices and receivers are also provided.

### IN THE DRAWINGS

FIG. 1 illustrates an example digital data receiver for providing a fast service scan, according to the invention;

FIG. 2 illustrates an example frequency space, according to the invention; and

FIG. 3 illustrates an example method for providing a fast service scan, according to the invention.

### In all the Figures, corresponding parts are referenced by the same reference numerals.

In various digital data transmission standards, only a fixed number of frequencies are mentioned that will be used in a transmission. This number of frequencies is significantly less than the total number of frequencies that would be searched in the conventional automatic search mode. A list of such frequencies can be found in various standards that are followed by different jurisdictions, including regions or countries. For example, the D-book standard is used in the UK and Australia, the E-book standard is used in Europe, and the NorDig standard covers Norway, Sweden, Finland and Denmark. On top of these standards, some countries have their own standards, usually with extensions to the basic standard they use. For example, the specification used by Australia is based on an extension of the D-book.

The invention takes advantage of the above observation to provide a way to perform a fast service scan. Using a fixed grid, the receiver can scan the full range much quicker than by performing a continuous scan. In one possible approach, the invention can be implemented by combining all possible frequencies used in Europe in one frequency table, based on a combination of country-specific and general standards. For example, one European frequency table can combine the E-book, D-book and NorDig transmission standards. Another table can be provided for Australian frequencies. When a service scan is performed, only the frequencies in a particular grid or table are scanned based on a user setting in the receiver. Depending on the geographic location of the receiver, the user can provide a setting to inform the receiver of which transmissions standard is being used to enable the receiver to identify the appropriate frequencies to scan. Since fewer frequencies are scanned, a service scan that can be completed in under twenty seconds or so. Moreover, the same receiver can be used in different geographical locations where different transmission standards are used by only setting the country/region setting for the receiver. This reduces manufacturing, distribution and installation costs of the receiver.

Furthermore, to overcome the problem of having a frequency table that is fixed in the receiver, and the fact that sometimes the used frequencies change, such as occurred in Australia, for example, the frequency table can be updated as required, e.g., via a software download and/or flash card. In practice, usually these frequency ranges are quite stable. The procedure disclosed herein advantageously results in a frequency scan that is ten to twenty times faster than usual.

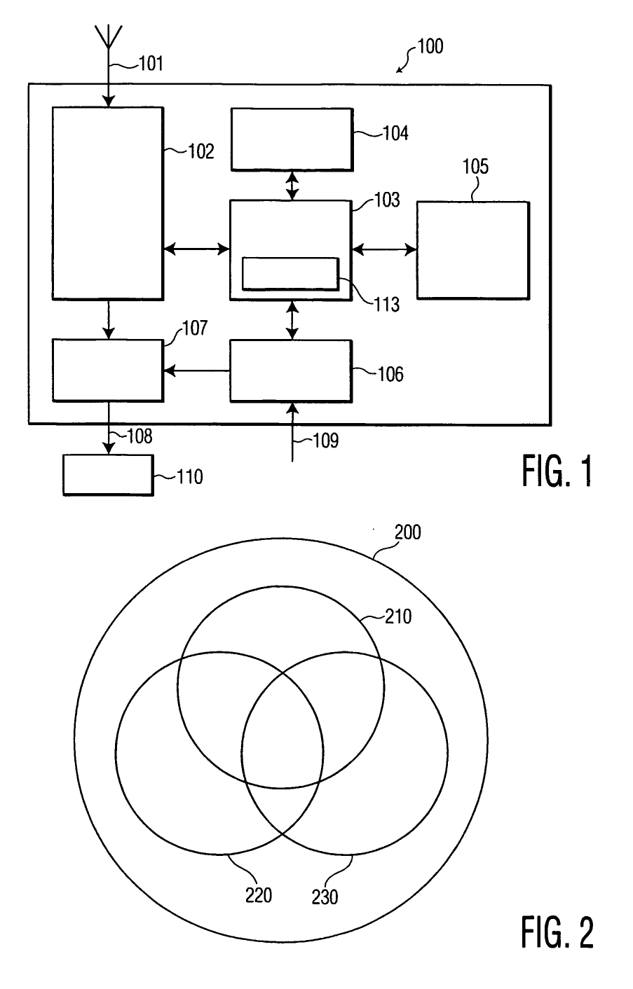

FIG. 1 illustrates an example digital data receiver for providing a fast service scan, according to the invention. Block 102 is a “tuner and decoder. ” Block 103 is “control circuitry. ” Block 113 is a “memory”. Block 104 is a “Frequency data ” memory. Block 105 is a “country/region setting ” memory. Block 107 is “output circuitry”. Block 106 is a “user interface. ” Block 110 is a “display”.

In one possible approach, the invention is implemented using components within a television set-top box receiver, e.g., receiver 100 that receives a television signal via an input path 101, such as an antenna, and outputs a signal for display on the display device 110, such as a television, via a signal output path 108. However, the invention is generally applicable to any type of device that receives video and/or audio programs. For example, the invention may be implemented in a computer that receives video programs from a network such as the Internet, e.g., by downloading, streaming or broadcasting, such as webcasting. The video programs typically include an audio track although this is not required. Moreover, the invention can be used with audio-only programs such as those provided via the Internet, e.g., as webcasts, or via radio broadcasts, including terrestrial and satellite radio broadcasts. The invention can also be used with a transmission that includes a data service, where no audio or video is required.

The receiver 100 tunes, demultiplexes and decodes the received programs at a tuner/decoder 102. The programs may be provided in a digital or analog multiplex that is transmitted by cable, satellite, or terrestrial broadcast, for example. Generally, one of the programs is decoded based on a channel selection made by the user/viewer via a handheld remote control. A user input signal from the remote control is processed by a user interface function 106 in the receiver 100. The remote control may use any type of communication path 109, such as infrared, wired, ultrasound, radio frequency, etc. When the user selects a channel via the user interface 106, the control circuitry 103 recovers the corresponding program, e.g., using information such as packet identifiers (PIDs), from the received transmission.

The decoded program may be communicated to the display device 10 via output circuitry 107 or stored locally for subsequent display. The control circuitry 103, such as a microprocessor with a working memory 113, may interact with the tuner/decoder 102 to control the functions of the tuner/decoder 102. The working memory 113 may be considered a program storage device that stores software that is executed by the control circuitry 103 to achieve the functionality described herein. However, resources for storing and processing instructions such as software to achieve the desired functionality may be provided using any known techniques.

The control circuitry 103 stores frequency data in a frequency data memory 104. The frequency data can be in table form, for example, and obtained via a software download and/or flash card. The frequency data can also be updated similarly, if required. The frequency data can include data used by the control circuitry 103 in controlling the tuner/decoder 102 to tune to specific frequencies that are associated with a transmission standard. The data can include center frequency values, for instance. Other tuning parameters can also be included, such as FFT mode and guard interval. Moreover, the frequency data can specify the bandwidth of a transmission, which is an important parameter after the frequency itself. In one possible implementation, the frequency data includes only combinations of frequency and bandwidth.

The scanning process can be adjusted by varying these parameters. The frequency data may be organized so that the frequencies associated with different transmission standards, e.g., different countries or regions, can be identified and retrieved.

A country and/or region setting, e.g., a jurisdiction setting, may be stored in a memory 105 for use by the control circuitry 103 in its decision-making processes. The region can be a group of countries, or a portion of one country, for instance. The memories 104 and 105 are shown as being separate but may be combined with other memory resources. The country and/or region setting may be provided by the user via the user interface 106, or via a hardware switch such as a dual in-line pole (DIP) switch or the like. The country and/or region settings may be associated with one or more transmission standards. The control circuitry 103 can identify the frequencies of a particular transmission standard in the frequency data memory 104 based on the country/region setting in the memory 105. When the frequencies of only one transmission standard are stored in the memory 104, there is no need for a separate country/region setting to distinguish between different groups of frequencies.

FIG. 2 illustrates an example frequency space, according to the invention. The frequency space is a Venn diagram that indicates frequencies that can be tuned by the receiver 100. The frequency space 200 indicates the entire range of frequencies that the receiver is capable of tuning, e.g., a predetermined set of frequencies. For example, Sweden follows the NorDig II specification. In this case, the receiver is capable of receiving all channels in the UHF bands IV and V (channels 21-69). Specifically, the tuner is capable of tuning to the center frequency f_{c} of an incoming DVB-T RF signal, where f_{c}=474 MHz+(N−21)×8 MHz+f_{fine}, N∈{21, . . . , 69 }, and f_{fine} ∈[−10 kHz, 10 kHz]. N is the channel number, and f_{fine} is the continuous fine frequency offset range. The frequency spaces 210, 220, and 230 indicate the frequencies that are associated with first, second and third transmission standards, respectively. As an example only, some overlap between frequencies is shown for the frequency spaces 210, 220 and 230, but this is not necessarily the case. The frequency spaces 210, 220, and 230 are each subsets of the frequency space 200.

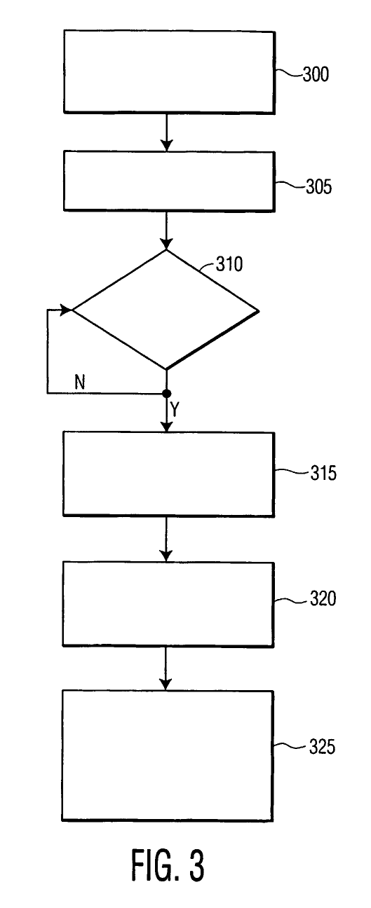

FIG. 3 illustrates an example method for providing a fast service scan, according to the invention. Block 300 states “Identify transmission frequencies for different standards”. Block 305 states “Store frequencies in receiver.” Block 310 asks “Reset or installation?” Block 315 states “Identify standard associated with received transmission. ” Block 320 states “Retrieve stored frequencies for identified standard.” Block 325 states “Scan only frequencies for identified standard to locate services in the received transmission. ”

At block 300, the transmission frequencies for one or more transmission standards are identified. These frequencies can be obtained from the documentation of the standards, which is publicly available. At block 305, the frequencies are stored in the receiver 100, such as in the frequency data memory 104, e.g., via a software download, flash card or pre-programming at the time of manufacture. At block 310, it is determined whether a reset or installation of the receiver has occurred. In these situations, a service scan is needed to recover and identify the received programming services. If a service scan is indicated, the standard associated with the received transmission is identified at block 315, e.g., based on the data in the country/region setting memory 105. At block 320, the stored frequencies for the identified transmission standard are recovered from the frequency data memory 104, and used to control the tuner/decoder 102 to tune to the specific frequencies to recover the data services of the received transmission. In particular, at block 325, the tuner/decoder 102 scans only the frequencies for the identified standard. The tuner/decoder 102 may tune to the frequencies sequentially, from lowest to highest, for instance.

While there has been shown and described what are considered to be preferred 25 embodiments of the invention, it will, of course, be understood that various modifications and changes in form or detail could readily be made without departing from the spirit of the invention. It is therefore intended that the invention not be limited to the exact forms described and illustrated, but should be construed to cover all modifications that may fall within the scope of the appended claims.

What is claimed is:

1. A method for receiving a digital data transmission, the method comprising:
storing (305) data identifying frequencies (210, 220, 230) at which digital data is transmitted according to different transmission standards;
identifying (315) a particular one of the different transmission standards that is associated with the received digital data transmission; and
locating programming services in the received digital data transmission by controlling a tuner to scan (325) only the identified frequencies associated with the particular one of the different transmission standards.

2. The method of claim 1, wherein:
the different transmission standards are associated with respective different jurisdictions.

3. The method of claim 1, wherein:
the different transmission standards are associated with respective different countries.

4. The method of claim 1, wherein:
the identifying the particular one of the different transmission standards comprises receiving a user setting via a user interface (106).

5. The method of claim 1, wherein:
the received digital data transmission is provided according to a Digital Video Broadcasting standard.

6. The method of claim 1, wherein:
the received digital data transmission comprises at least one of audio and video data.

7. The method of claim 1, wherein:
the received digital data transmission comprises a data service.

8. The method of claim 1, wherein:
the received digital data transmission is provided in at least one of respective broadcasts, multicasts and streaming content.

9. The method of claim 1, further comprising:
storing data identifying bandwidths associated with the frequencies at which the digital data is transmitted according to the different transmission standards,
wherein the locating of the programming services is responsive to the data identifying the bandwidths.

10. A program storage device tangibly embodying a program of instructions executable by a machine to perform a method for receiving a digital data transmission, the method comprising:
storing (305) data identifying frequencies (210, 220, 230) at which digital data is transmitted according to different transmission standards;
identifying (315) a particular one of the different transmission standards that is associated with the received digital data transmission; and
locating programming services in the received digital data transmission by controlling a tuner to scan (325) only the identified frequencies associated with the particular one of the different transmission standards.

11. A receiver for receiving a digital data transmission, the receiver comprising:
at least one memory (104, 105) for storing data identifying frequencies (210, 220, 230) at which digital data is transmitted according to different transmission standards, and for storing data identifying a particular one of the different transmission standards that is associated with a received digital data transmission;
a control (103) associated with the at least one memory; and
a tuner (102) responsive to the control for locating programming services in the received digital data transmission by scanning only the identified frequencies associated with the particular one of the different transmission standards.

12. A receiver for receiving a digital data transmission, the receiver comprising:
a tuner (102) that is capable of scanning a predetermined set of frequencies (200);
at least one memory (104) for storing data identifying a subset (210, 220, 230) of the predetermined set of frequencies at which digital data is transmitted according to at least one transmission standard; and
a control (103) associated with the at least one memory for controlling the tuner (102) to locate programming services in the received digital data transmission by scanning only the subset of the predetermined set of frequencies.

13. The receiver of claim 12, wherein:
the at least one memory (104, 105) stores data identifying frequencies at which the digital data is transmitted according to a plurality of transmission standards.

14. The receiver of claim 12, wherein:
the plurality of transmission standards includes E-book, D-book and NorDig.

15. The receiver of claim 12, wherein:
the control (103) is associated with the at least one memory (104, 105) for controlling the tuner (102) to locate the programming services in the received digital data transmission by scanning only the identified frequencies for a selected one of the transmission standards that is associated with the received digital data transmission.

16. A method for configuring a receiver to receive a digital data transmission, wherein the receiver includes a tuner that is capable of scanning a predetermined set of frequencies, and at least one memory, the method comprising:
storing data in the at least one memory (104, 105) for identifying a subset (210, 220, 230) of the predetermined set (200) of frequencies at which digital data is transmitted according to at least one transmission standard; and
controlling the tuner (102) to locate programming services in the received digital data transmission by scanning only the subset of the predetermined set of frequencies.

17. The method of claim 16, wherein:
the storing data in the at least one memory (104, 105) comprises storing data in the at least one memory for identifying frequencies at which the digital data is transmitted according to a plurality of transmission standards.

18. The method of claim 17, wherein:
the plurality of transmission standards includes E-book, D-book and NorDig.

19. The method of claim 16, wherein:
the controlling the tuner (102) comprises controlling the tuner to locate the programming services in the received digital data transmission by scanning only the identified frequencies for a selected one of the transmission standards that is associated with the received digital data transmission.

20. The method of claim 16, wherein:
the storing data in the at least one memory (104, 105) comprises storing data in the at least one memory for identifying bandwidths associated with the frequencies at which the digital data is transmitted according to the at least one transmission standard;
wherein the controlling the tuner (102) to locate the programming services is responsive to the data identifying the bandwidths.
